(19) United States
(12) Patent Application Publication
(10) Pub. No.: US 2013/0272029 A1
(43) Pub. Date: Oct. 17, 2013

(54) LIGHT SOURCE MODULE

(71) Applicants: Yi-Tsuo WU, KAOHSIUNG (TW); Yen-Chuan CHU, KAOHSIUNG (TW)

(72) Inventors: Yi-Tsuo WU, KAOHSIUNG (TW); Yen-Chuan CHU, KAOHSIUNG (TW)

(73) Assignee: RADIANT OPTO-ELECTRONICS CORPORATION, KAOHSIUNG (TW)

(21) Appl. No.: 13/490,435

(22) Filed: Jun. 6, 2012

(30) Foreign Application Priority Data
Apr. 13, 2012 (TW) 101113278

(51) Int. Cl. F21V 9/16; F21V 8/00

(52) U.S. Cl. 362/613

(57) ABSTRACT

A light source module is provided. The light source module includes a light guide element, at least one light source and a fluorescence member. The light guide element includes a light incident surface and a light-exiting surface. The light-exiting surface is opposite to the light incident surface. A light-emitting surface of the at least one light source faces the light incident surface of the light guide element. At least one section of the fluorescence member faces the light-exiting surface of the light guide element.

### RELATED APPLICATIONS

This application claims priority to Taiwan Patent Application Serial Number 101113278, filed on Apr. 13, 2012, which is herein incorporated by reference.

### BACKGROUND

1. Field of Invention

This application relates to a light source module, and more particularly to a light source module with a fluorescence member.

2. Description of Related Art

A conventional light source module often utilizes a tungsten lamp or a fluorescent lamp as a light source. However, the tungsten lamp or the fluorescent lamp has the deficiencies of large power consumption, less illumination efficacy and more heat generating, and thus the conventional light source does not meet the development tendency of modern lighting technologies and environmental requirements.

A LED (Light Emitting Diode) is a common point light source, which has the advantages of high efficacy and more power saving etc. Thus, the LED is desired to replace the conventional light source to overcome the deficiencies of the conventional skills.

Further, when the LED is desired to be applied to a light source module with a large area, a lot of LEDs are often required to be disposed therein so as to satisfy the requirements of the light source module. However, the light-emitting spectrum and intensity of the LEDs are often affected by the distribution of packaging materials including LED chips and phosphor, thus causing the light source module easily to have non-uniform light color or brightness due to the differences among light-emitting spectrum or intensities of the LEDs.

Moreover, when the LED is desired to be applied to a white light source module, a lot of blue LEDs, green LEDs and red LEDs are needed to be disposed to mix the colored lights emitted by the light source module to form white light. However, the large amount of LEDs will increase the volume of the light source module, and thus the light source module fails to meet the development tendency of lightness and thinness.

There are two methods in the current popular designs of white light source module. The first method is to dispose. light-emitting materials in encapsulation gel of LEDs, and the second method is to dispose light-emitting materials on a light guide plate. The first method is to excite the light-emitting materials by using the light emitted from the LEDs, such that the light emitted from the LEDs which is not absorbed by the light-emitting materials can be mixed with the light generated by exciting the light-emitting materials to form white light. However, with the increase of the light emitting time, the photo-conversion efficiency of the light-emitting materials will be easily affected by the heat generated from the LEDs.

Although the second method may prevent the light-emitting materials from being affected by the heat generated from the LEDs, if the process for disposing the light-emitting materials on the light guide plate is defected, the light guide plate cannot be used again. In addition, this method needs to use a large amount of light-emitting materials so as to prevent the light source module from having non-uniform light colors, thus greatly increasing the manufacture cost of the light source module.

In view of this, there is a need to provide a light source module for improving the deficiencies of the conventional light source modules.

### SUMMARY

Therefore, an aspect of the present invention is to provide a light source module for adjusting light color emitted from the light source module by utilizing photoluminescence materials to satisfy the light color requirements of various light source modules.

Another aspect of the present invention is to provide a light source module of which light-emitting materials do not contact light sources for preventing the photoconversion efficiency from being affected by the heat generated from the light sources, thereby prolonging the operational life of the light-emitting materials.

Yet another aspect of the present invention is to provide a light source module for using a light guide element to converge light-emitting regions of light sources and to effectively guide the light to a fluorescence member, thereby decreasing the usage amount of the light-emitting materials.

Yet another aspect of the present invention is to provide a light source module which utilizes a light guide element to sufficiently mix lights emitted from light sources to decrease the deficiencies of non-uniform light color and brightness caused by the differences among light-emitting spectrum or intensities of the light sources.

According to the aforementioned aspects of the present invention, a light source module is provided. In one embodiment, the light source module includes a light guide element, at least one light source and a fluorescence member. The light guide element includes a light incident surface and a light-exiting surface. The light-exiting surface is opposite to the light incident surface. A light-emitting surface of the light source faces the light incident surface of the light guide element. At least one section of the fluorescence member faces the light-exiting surface of the light guide element.

According to one embodiment of the present invention, the light guide element is a light guide plate with a uniform thickness.

According to another embodiment of the present invention, the light guide plate is formed from a polymeric material.

According to yet another embodiment of the present invention, the number of the at least one light source is more than one, and the light sources have at least one light-emitting wavelength.

According to yet another embodiment of the present invention, the fluorescence member includes a carrier and a plurality of light-emitting materials.

According to yet another embodiment of the present invention, the carrier is formed from a light-transparent material.

According to yet another embodiment of the present invention, the light-transparent material is a polymeric material or glass.

According to yet another embodiment of the present invention, the light-emitting materials include at least one photoluminescence material.

According to yet another embodiment of the present invention, the light-emitting materials are sprayed or coated on a surface of the carrier.

According to yet another embodiment of the present invention, the light-emitting materials are dispersed in the carrier.

According to the aforementioned aspects of the present invention, another light source module is provided. In one embodiment, the light source module includes a light guide element, at least one light source and a fluorescence member. The light guide element includes a light incident surface and a light-exiting surface. The light-exiting surface is opposite to the light incident surface. A light-emitting surface of the light source faces the light incident surface of the light guide element. At least one section of the fluorescence member faces the light-exiting surface of the light guide element. The fluorescence member includes a plurality of light-emitting materials, and the light-emitting materials include at least one photoluminescence material. The photoluminescence material includes but is not limited to a fluorescence material, a phosphorescence material or a combination thereof.

According to one embodiment of the present invention, the fluorescence material includes but is not limited to yttrium aluminum garnet, terbium aluminum garnet, silicate, sulfide, nitride, nitrogen oxide or a combination thereof.

According to yet another embodiment of the present invention, the phosphorescence material includes but is not limited to an ortho-silicate based phosphor, an organic metal complex with heavy metal atoms or a combination thereof.

The light-emitting materials of the light source module of the present invention do not contact the light sources for preventing the photo-conversion efficiency from being affected by the heat generated form the light sources.

Furthermore, the light source module may use a light guide element to converge the light-emitting regions of the light sources and to effectively guide the light to a fluorescence member, thereby decreasing the volume of the fluorescence member, thus decreasing the usage amount of the light-emitting materials, further decreasing the manufacture cost. The light guide element also can sufficiently mix the lights emitted from the light sources to decrease the disadvantages of non-uniform light color and brightness caused by the difference among the light-emitting spectrum or intensities of the light sources.

Moreover, the light source module can adjust the light color emitted from the light source module by utilizing the photoluminescence materials, thus satisfying the light color requirements of various light source modules.

### BRIEF DESCRIPTION OF THE DRAWINGS

The invention can be more fully understood by reading the following detailed description of the embodiment, with reference made to the accompanying drawings as follows:

FIG. 1 is a cross-sectional view of a light source module according to one embodiment of the present invention; and

FIG. 2 is a cross-sectional view of a light source module according to another embodiment of the present invention.

### DETAILED DESCRIPTION

In the following description, several specific details are presented to provide a thorough understanding of the device structures according to embodiments of the present invention. One skilled in the relevant art will recognize, however, that the embodiments of the present invention provide many applicable inventive concepts which can be practiced in various specific contents. The specific embodiments discussed hereinafter are used for explaining but not limiting of the scope of the present invention.

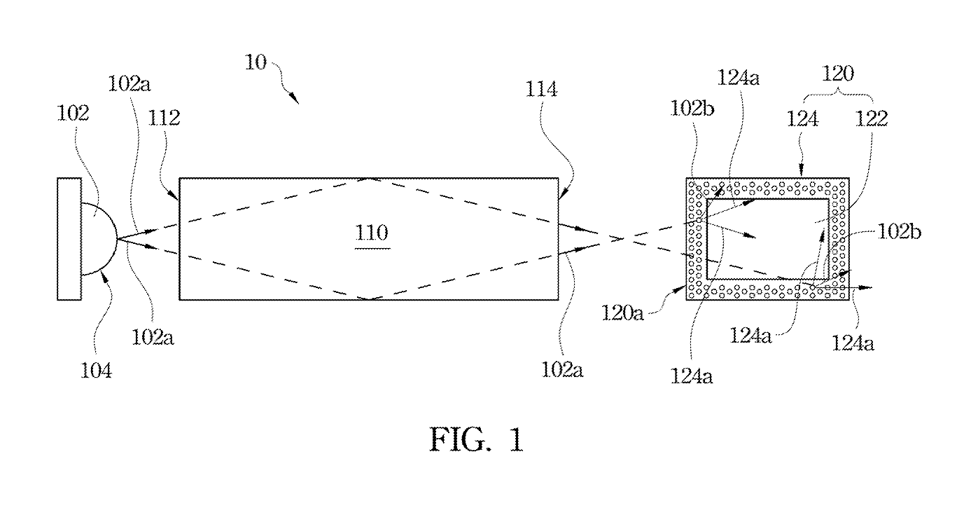

Referring to FIG. 1. FIG. 1 is a cross-sectional view of a light source module according to one embodiment of the present invention. A light source module 10 includes a light guide element 110, one or more light sources 102 and a fluorescence member 120. The light guide element 110 has a light incident surface 112 and a light-exiting surface 114. The light-exiting surface 114 and the light incident surface 112 are disposed on the opposite sides of the light guide element 110. In one embodiment, the light guide element 110 is a light guide plate with a uniform thickness. In the embodiment, the light guide plate is formed from a polymeric material such as PMMA (Polymethylmethacrylate) or PC (Polycarbonate).

The light source 102 has a light-emitting surface 104 facing the light incident surface 112 of the light guide element 110. In one embodiment, the light sources 102 may include a light emitting diode, a laser diode, another suitable point light source or combinations thereof.

The fluorescence member 120 has a section 120a facing the light-exiting surface 114 of the light guide element 110. The fluorescence member 120 may include a carrier 122 and light-emitting materials 124. The light-emitting materials 124 may include one or more photoluminescence materials used to adjust the light color emitted from the light source module 10, thereby satisfying the light color requirements of the light source module 10.

In one embodiment, the photoluminescence materials may include a fluorescence material, a phosphorescence material, another suitable photoluminescence material or combinations thereof. In the embodiment, the fluorescence materials may include YAG (Yttrium Aluminum Garnet), TAG (Terbium Aluminum Garnet), silicate such as Ba₂SiO₄:Eu²⁺, Sr₄Si₃O₈Cl₄:Eu²⁺ and BaSi₂O₅:Pb²⁺, sulfide such as Ba₂ZnS₃:Ce³⁺, nitride such as CaAlSiN₃:Eu²⁺ and CaAlSiN₃, nitrogen oxide such as Ba₃Si₆O₁₂N₂:Eu and SrSi₂O₂N₂, another suitable fluorescence material or combinations thereof. In the embodiment, the phosphorescence materials may include an ortho-silicate based phosphor, an organic metal complex with heavy metal atoms such as transition metal atoms, another suitable phosphorescence materials or combinations thereof.

In one embodiment, the carrier 122 is formed from a light-transparent material. The light-transparent material is a polymeric material, glass or another suitable material. In one embodiment, the light-emitting materials 124 are formed on a surface of the carrier 122 by a spraying method. In another embodiment, the light-emitting materials 124 are formed on a surface of the carrier 122 by a coating method.

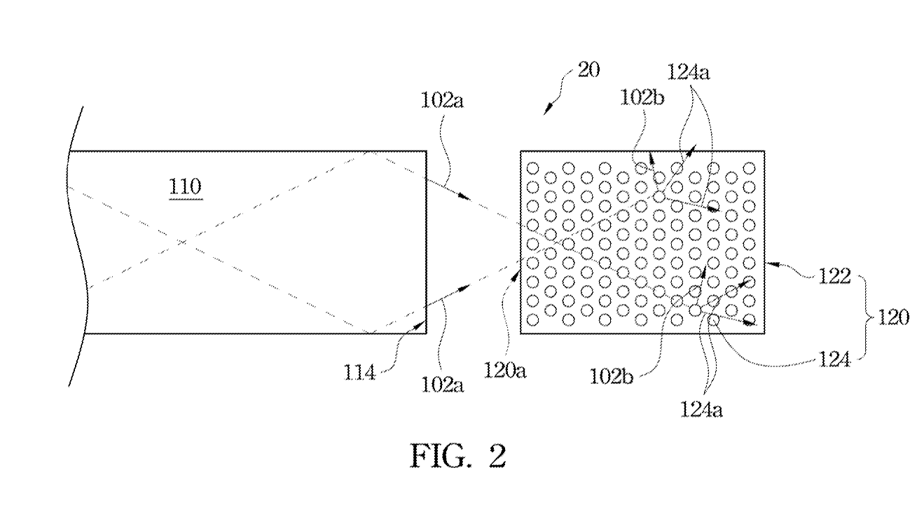

In yet another embodiment, referring to FIG. 2, a light source module 20 is substantially similar to the light source module 10 in structure but the difference between the light source module 20 and the light source module 10 is that the light-emitting materials 124 of the light source module 20 are blended in the material forming the carrier 122, and then the carrier 122 is formed by compression molding, injection molding, extrusion molding or other molding processes, such that the light-emitting materials 124 is uniformly dispersed in the carrier 122.

In one embodiment, for satisfying the absorption wavelength ranges of the aforementioned photoluminescence materials and the light color and the light-emitting intensity of the light source module, the number of the light sources 120 may be more than one, and the light sources 120 may have at least one light-emitting wavelength.

Referring to FIG. 1 again, in one embodiment, light 102a emitted from the light sources 102 enters the light guide element 110 from the light incident surface 112. The light 102a is totally reflected in the light guide element 110, and then leaves the light guide element 110 from the light-exiting surface 114. The light 102a emitted from the light guide element 110 illuminates the light-emitting materials 124 in the fluorescence member 120, in which a portion of the light 102a is absorbed by the light-emitting materials 124, thereby exciting the light-emitting materials 124 from a ground state to an excited state. When returning to the ground state from the excited state, the light-emitting materials 124 emit excited light 124a. The other portion of light 102a which is not absorbed by the light-emitting materials 124 is reflected to form a reflected light 102b. Therefore, the light color emitted from the light source module 10 is the light color of the excited light 124a mixed with the reflected light 102b. In one embodiment, by using the carrier 122 with different light-emitting materials 124 can adjust the light color and the light-emitting intensity of the light source module 10 so as to satisfy the light color and brightness requirements of various light source modules.

Referring to FIG. 2, similarly, in a light source module 20, the light 102a emitted from the light-exiting surface 114 of the light guide element 110 illuminates the light-emitting materials 124 in the fluorescence member 120, in which a portion of the light 102a is absorbed by the light-emitting materials 124, thereby exciting the light-emitting materials 124 from the ground state to the excited state. When the light-emitting materials 124 returns to the ground state from the excited state, the light-emitting materials 124 emit an excited light 124a. The other portion of light 102a which is not absorbed by the light-emitting materials 124 is reflected to form the reflected light 102b. Therefore, the light color emitted from the light source module 20 is the light color of the excited light 124a mixed with the reflected light 102b.

It can be known from the aforementioned embodiments that, the light-emitting materials of the present invention do not contact the light sources, such that the photo-conversion efficiency can be prevented from being affected by the heat generated from the light sources, thereby prolonging the operational life of the light-emitting materials.

The present invention may also use a light guide element to converge the light-emitting regions of the light sources and to effectively guide the light to the fluorescence member, thus ensuring that all of the light emitted from the light sources illuminates the light-emitting materials in the fluorescence member. Hence, the present invention can decrease the volume of the fluorescence member, thus decreasing the usage amount of the light-emitting materials, further decreasing the manufacture cost. Furthermore, the light guide element can sufficiently mix the lights emitted from the respective light sources to decrease the disadvantages of non-uniform light color or brightness caused by the difference among light-emitting spectrum or intensities of the light sources.

Moreover, the present invention can adjust the light color emitted from the light source modules by utilizing the photoluminescence materials, so as to satisfy the requirements of various requirements. Moreover, a semiconductor light-emitting element such as a LED is used as the light source of the present invention to allow the light source module to have advantages of high brightness, power saving and light weigh, etc., thereby meeting the development tendency of modern technologies and environmental requirements, and improving the deficiencies of the conventional light source modules.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded with the broadest interpretation so as to encompass all such modifications and similar structures.

What is claimed is:

1. A light source module, comprising:
a light guide element, comprising:
a light incident surface; and
a light-exiting surface opposite to the light incident surface;
at least one light source of which a light-emitting surface faces the light incident surface of the light guide element; and
a fluorescence member of which at least one section faces the light-exiting surface of the light guide element.

2. The light source module of claim 1, wherein the light guide element is a light guide plate with a uniform thickness.

3. The light source module of claim 2, wherein the light guide plate is formed from a polymeric material.

4. The light source module of claim 3, wherein the polymeric material is polymethylmethacrylate or polycarbonate.

5. The light source module of claim 1, wherein the number of the at least one light source is more than one, and the light sources have at least one light-emitting wavelength.

6. The light source module of claim 1, wherein the fluorescence member includes a carrier and a plurality of light-emitting materials.

7. The light source module of claim 6, wherein the carrier is formed from a light-transparent material.

8. The light source module of claim 7, wherein the light-transparent material is a polymeric material or glass.

9. The light source module of claim 6, wherein the light-emitting materials include at least one photoluminescence material.

10. The light source module of claim 9, wherein the at least one photoluminescence material is selected from the group consisting of a fluorescence material, a phosphorescence material and a combination thereof.

11. The light source module of claim 10, wherein the fluorescence material is selected from the group consisting of yttrium aluminum garnet, terbium aluminum garnet, silicate, sulfide, nitride, nitrogen oxide and a combination thereof.

12. The light source module of claim 10, wherein the phosphorescence material is selected from the group consisting of ortho-silicate based phosphor, organic metal complex with heavy metal atoms and a combination thereof.

13. The light source module of claim 6, wherein the light-emitting materials are sprayed or coated on a surface of the carrier.

14. The light source module of claim 6, wherein the light-emitting materials are dispersed in the carrier.

15. A light source module, comprising:
a light guide element, comprising:
a light incident surface; and
a light-exiting surface opposite to the light incident surface;
at least one light source of which a light-emitting surface faces the light incident surface of the light guide element; and
a fluorescence member of which at least one section faces the light-exiting surface of the light guide element, wherein the fluorescence member includes:
a. plurality of light-emitting materials include at least one photoluminescence material, wherein the at least one photoluminescence material is selected from the group consisting of a fluorescence material, a phosphorescence material and a combination thereof.

16. The light source module of claim 15, wherein the fluorescence material is selected from the group consisting of yttrium aluminum garnet, terbium aluminum garnet, silicate, sulfide, nitride, nitrogen oxide and a combination thereof.

17. The light source module of claim 15, wherein the phosphorescence material is selected from the group consisting of ortho-silicate based phosphor, organic metal complex with heavy metal atoms and a combination thereof.
